(19) United States
(12) Patent Application Publication
(10) Pub. No.: US 2016/0103557 A1
(43) Pub. Date: Apr. 14, 2016

(54) TOUCH DETECTION DEVICE FOR TOUCHSCREEN

(71) Applicant: Asia Vital Components Co., Ltd., New Taipei City (TW)

(72) Inventors: Cheng-Nan Lien, New Taipei City (TW); Jinhua Tan, New Taipei City (TW); Zijun Meng, New Taipei City (TW); Chih-Wei Chang, New Taipei City (TW)

(21) Appl. No.: 14/510,997

(22) Filed: Oct. 9, 2014

(51) Int. Cl. G06F 3/042

(52) U.S. Cl. CPC G06F 3/0421

(57) ABSTRACT

A touch detection device for touchscreen includes a frame and at least one printed circuit board mounted on one face of the frame. The printed circuit boards have a plurality of transmitters, a plurality of receivers, and a wireless signal transmission unit mounted thereon. By using the transmitters and the receivers to detect touched positions on a touchscreen, and using the wireless signal transmission unit to transmit a touch signal, the touch detection device can be conveniently installed on the touchscreen with simplified cable wiring and avoid the risk of being undesirably pulled by an external force to adversely affect the signal transmission thereof.

### FIELD OF THE INVENTION

The present invention relates to a touch detection device for touchscreen, and more particularly to a touch detection device for touchscreen that includes infrared transmitters and receivers for detecting touch positions and wirelessly transmits touch signals.

### BACKGROUND OF THE INVENTION

Thanks to the constant progress in the electronic technology, the electronic products currently available in the market all have a small volume with a large display screen. However, with the large screen, there is almost not extra room on the products for their operating keys. Since operating keys are required to operate the electronic products, consumers' demand for touchscreen increases constantly.

Infrared touch technology is a technique being most widely adopted in developing big-size touchscreens. As shown in FIG. 1, a conventional infrared touch device includes a frame 11, on which a plurality of circuit boards 12 is mounted. On the circuit boards 12, a plurality of transmitters 121 and a plurality of receivers 122 are mounted in a predetermined sequence. The transmitters 121 and the receivers 122 are arranged on the circuit boards 12 in one-to-one correspondence, such that arrays of transmitters and receivers are formed along the edges of the frame 11 and any two adjacent arrays are located perpendicular to one another. Infrared rays emitted by the transmitters 121 and received by the receivers 122 together form an interlaced infrared network. Under control by a processor, the pairs of correspondingly located transmitter 121 and receiver 122 are separately electrically connected in a predetermined sequence, so as to detect whether any infrared ray between a pair of correspondingly located transmitter 121 and receiver 122 is interrupted and accordingly determine whether a touch occurs.

The circuit boards 12 further have an electrical connection line 123 connected thereto. The electrical connection line 123 has an end electrically connected to the circuit boards 12 and the processor, and another end provided with a connector 124 for connecting to a computer case 13. The connector 124 can be a USB connector or a 1394 connector. When the processor detects that an infrared ray between a pair of corresponding transmitter and receiver is interrupted, indicating a touch occurs, the processor sends out a touch signal via the electrical connection line 123 to the computer case 13. Since the infrared touch device is connected to the computer case 13 via the electrical connection line 123, the electrical connection line 123 largely limits the positions at where the infrared touch device and the computer case 13 can be installed. Further, the electrical connection line 123 is subject to undesirable pulling by an external force to cause poor signal transmission or even damage to the infrared touch device and the computer case 13. Therefore, the position of the electrical connection line 123 relative to the infrared touch device and the computer case 13 must be particularly arranged to prevent the infrared touch device and the computer case 13 from being unexpectedly pulled and damaged.

In brief, the conventional infrared touch device has the following disadvantages: (1) it could not be freely and conveniently installed at a desired position; (2) it is subject to unexpected pulling by an external force to cause poor signal transmission or even damage thereto; and (3) it requires additional cable wiring to other electronic device.

It is therefore tried by the inventor to develop a touch detection device for touchscreen to overcome the drawbacks of the conventional infrared touch device.

### SUMMARY OF THE INVENTION

A primary object of the present invention is to provide a touch detection device for touchscreen that includes infrared transmitters and receivers for detecting touch positions and wirelessly transmits touch signals.

To achieve the above and other objects, the touch detection device for touchscreen according to the present invention includes a frame and at least one printed circuit board. The frame includes a first edge, a second edge, a third edge and a fourth edge. The printed circuit boards are mounted on one face of the frame and have a plurality of transmitters, a plurality of receivers and a wireless signal transmission unit mounted thereon. By using the transmitters and the receivers to detect touched positions on a touchscreen, and using the wireless signal transmission unit to transmit touch signals, the touch detection device of the present invention can be conveniently installed with simplified cable wiring and avoid the risk of being undesirably pulled by an external force to cause poor signal transmission thereof. In brief, the touch detection device for touchscreen according to the present invention has the following advantages: (1) it can be conveniently installed; (2) it avoids the risk of being pulled by an external force to cause poor signal transmission thereof; and (3) it saves the steps of cable wiring to another electronic device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a conventional infrared touch device;

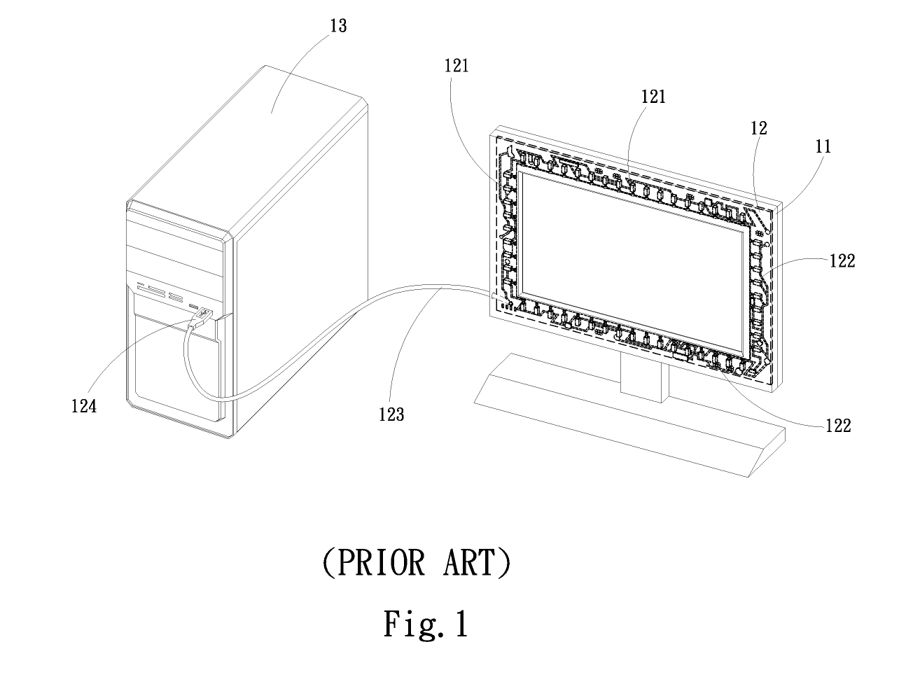

FIG. 2 is an exploded perspective view of a touch detection device for touchscreen according to a preferred embodiment of the present invention;

FIG. 3 shows a first example of application of the touch detection device for touchscreen according to the present invention; and

FIG. 4 shows a second example of application of the touch detection device for touchscreen according to the present invention.

### DETAILED DESCRIPTION OF THE PREFERRED EMBODIMENTS

The present invention will now be described with a preferred embodiment thereof and by referring to the accompanying drawings.

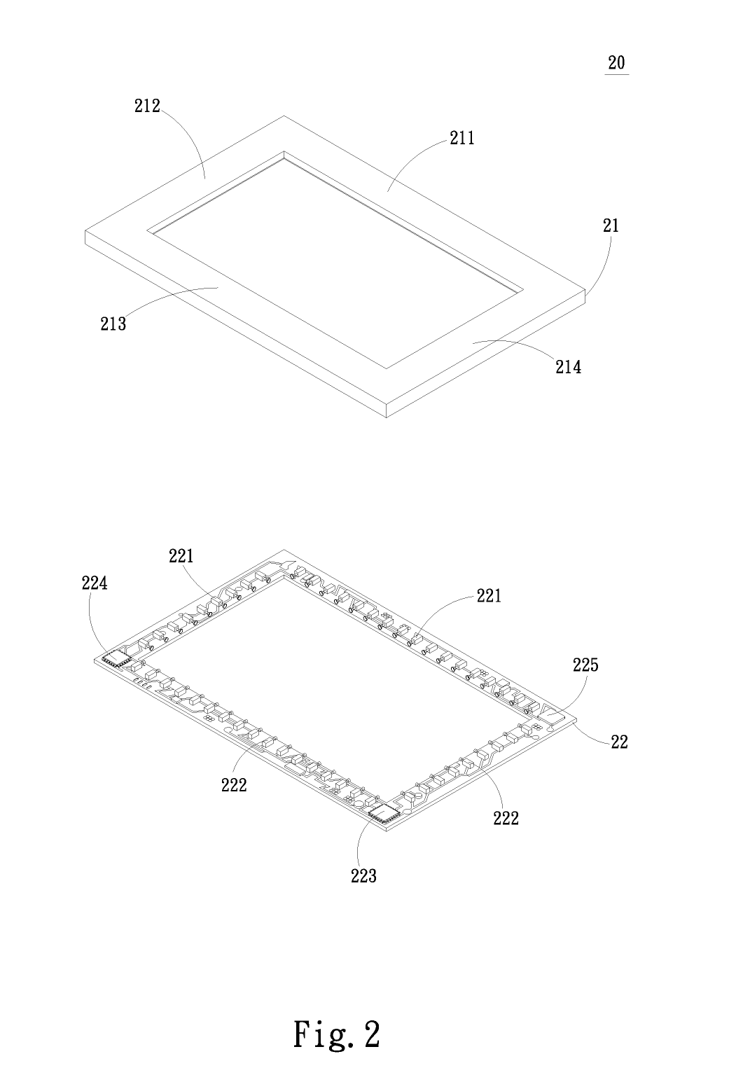

Please refer to FIG. 2 that is an exploded perspective view of a touch detection device for touchscreen according to a preferred embodiment of the present invention. For the purpose of conciseness and clarity, the present invention is also briefly referred to as the touch detection device and generally denoted by reference numeral 20 herein. As shown, the touch detection device 20 includes a frame 21 and at least one printed circuit board (PCB) 22.

The frame 21 includes four edges, namely, a first edge 211, a second edge 212, a third edge 213 and a fourth edge 214. The first edge 211 and the third edge 213 form a first pair of two opposite edges of the frame 21, and the second edge 212 and the fourth edge 214 form a second pair of two opposite edges of the frame 21. The PCBs 22 are mounted on one face of the frame 21 and have a plurality of transmitters 221, a plurality of receivers 222 and a wireless signal transmission unit 223 mounted thereon. The wireless signal transmission unit 223 is electrically connected to the transmitters 221 and the receivers 222.

In the illustrated preferred embodiment, the transmitters 221 located corresponding to the first edge 211 and the receivers 222 located corresponding to the third edge 213 are arranged on the same horizontal level, and the transmitters 221 located corresponding to the second edge 212 and the receivers located corresponding to the fourth edge 214 are also arranged on the same horizontal level; and, the transmitters 221 located corresponding to the first edge 211 and the receivers 222 located corresponding to the third edge 213 are arranged to align with one another, and the transmitters 221 located corresponding to the second edge 212 and the receivers 222 located corresponding to the fourth edge 214 are also arranged to align with one another.

The transmitters 221 and the receivers 222 are welded onto the PCBs 22 to locate corresponding to the two pairs of opposite edges of the frame 21. In the illustrated preferred embodiment, the transmitters 221 and the receivers 222 are described as infrared transmitters 221 and infrared receivers 222, respectively; the transmitters 221 are located corresponding to the first edge 211 and the second edge 212 of the frame 21; and the receivers 222 are located corresponding to the third edge 213 and the fourth edge 214 of the frame 21. However, the above arrangements of the transmitters 221 and receivers 222 are only illustrative and not intended to limit the present invention in any way. For example, the transmitters 221 can be located corresponding to the third edge 213 and the fourth edge 214 of the frame 21, and the receivers 222 221 can be located corresponding to the first edge 211 and the second edge 212 of the frame 21.

In the present invention, the wireless signal transmission unit 223 can be any one of a Bluetooth, a HYperLAN, a Triple Play, a GSM/GPRS, a 3G, a 3.5G, a 4G, an IEEE 802.11, an IEEE 802.3, an 802.15, an 802.11, and a Wi-Fi Direct signal transmission unit. In the illustrated preferred embodiment, the wireless signal transmission unit 223 is described as a device using Wi-Fi. Further, the PCBs 22 also have a processing unit 224 and a power supply unit 225 mounted thereon. The power supply unit 225 is electrically connected to the wireless signal transmission unit 223, the transmitters 221 and the receivers 222 for supplying electric power to them. When the transmitters 221 and the receivers 222 detect a position on a touchscreen is touched, the processing unit 214 calculates and then sends a touch signal to the wireless signal transmission unit 223 for transmitting. By using the transmitters 221 and the receivers 222 to detect touched positions on the touchscreen, and using the wireless signal transmission unit 223 to transmit touch signals, the touch detection device 20 of the present invention can be conveniently installed at a desired position with simplified cable wiring and avoid the risk of being undesirably pulled by an external force to adversely affect the signal transmission thereof.

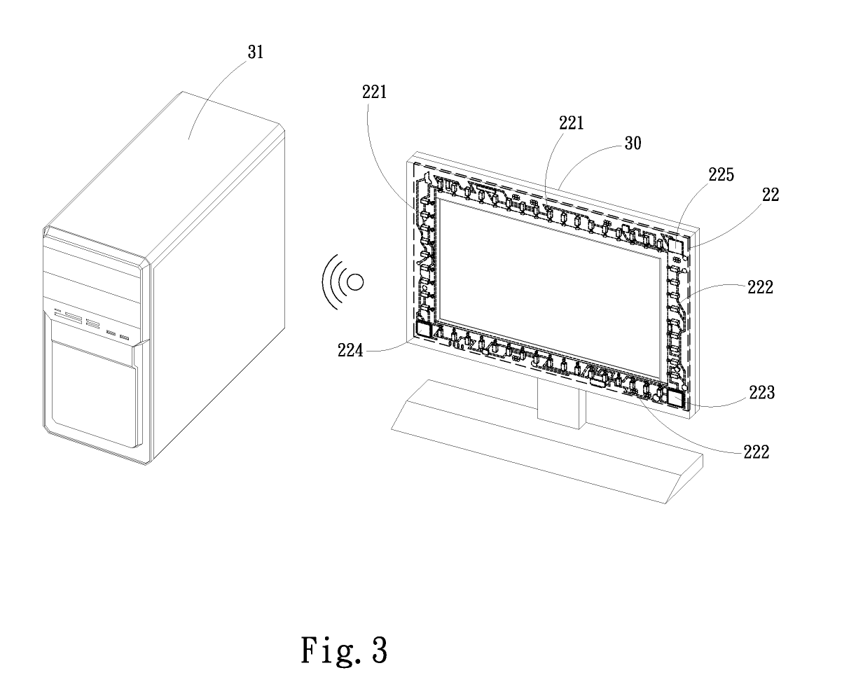

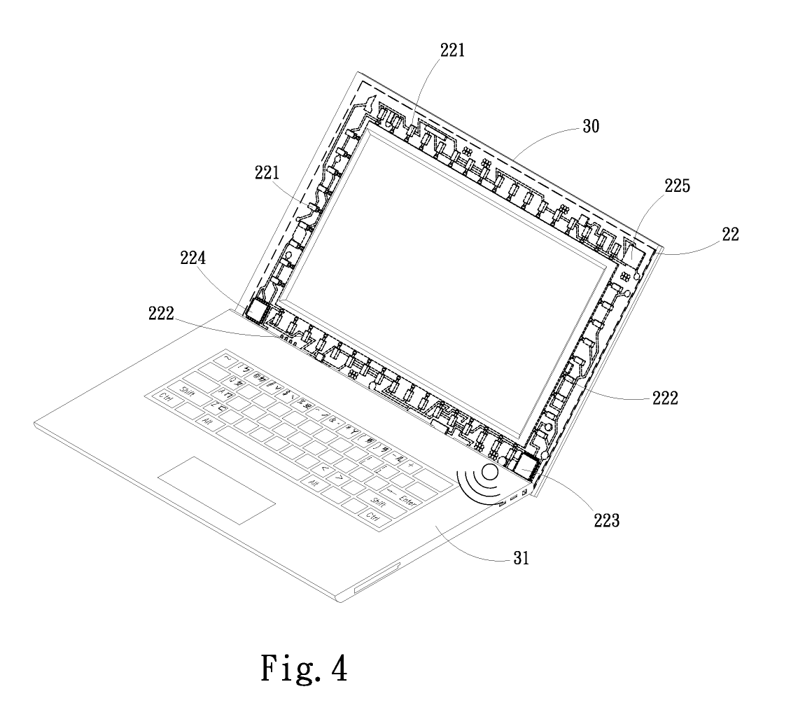

FIGS. 3 and 4 show two examples of application of the preferred embodiment of the present invention. In these examples of application, the touch detection device 20 is correspondingly installed on a display device 30. When the transmitters 221 and the receivers 222 detect a touched position on the display device 30, the processing unit 224 calculates and sends a touch signal to the wireless signal transmission unit 223, and the wireless signal transmission unit 223 wirelessly transmits the touch signal to a wireless signal receiving unit (not shown) of an electronic device 31, which in turn sends the received touch signal to the display device 30, so that the display device 30 displays and operates in response to the touch signal. With the above arrangements, that is, using the transmitters 221 and the receivers 222 to detect touched positions on the display device 30 and using the wireless signal transmission unit 223 to transmit the touch signal, the touch detection device 20 of the present invention can be conveniently installed on the display device 30 without the risk of being undesirably pulled by an external force to cause poor signal transmission thereof. Moreover, the cable wiring between the touch detection device 20 and the electronic device 31 can be simplified or even saved.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A touch detection device for touchscreen, comprising:
a frame including a first edge, a second edge, a third edge and a fourth edge that are sequentially arranged; and
at least one printed circuit board being mounted on one face of the frame and having a plurality of transmitters, a plurality of receivers and a wireless signal transmission unit mounted thereon.

2. The touch detection device for touchscreen as claimed in claim 1, wherein the transmitters are located corresponding to the first edge and the second edge of the frame.

3. The touch detection device for touchscreen as claimed in claim 1, wherein the transmitters are located corresponding to the third edge and the fourth edge of the frame.

4. The touch detection device for touchscreen as claimed in claim 1, wherein the printed circuit boards further have a power supply mounted thereon.

5. The touch detection device for touchscreen as claimed in claim 1, wherein the wireless signal transmission unit can be any one of a Bluetooth, a HYperLAN, a Triple Play, a GSM/GPRS, a 3G, a 3.5G, a 4G, an IEEE 802.11, an IEEE 802.3, an 802.15, an 802.11, and a Wi-Fi Direct signal transmission unit.

6. The touch detection device for touchscreen as claimed in claim 4, wherein the power supply unit is electrically connected to the wireless signal transmission unit, the transmitters and the receivers.

7. The touch detection device for touchscreen as claimed in claim 1, wherein the transmitters and the receivers are infrared transmitters and infrared receivers, respectively.

8. The touch detection device for touchscreen as claimed in claim 1, wherein the wireless signal transmission unit wirelessly transmits a touch signal to a wireless signal receiving unit provided on an electronic device.

9. The touch detection device for touchscreen as claimed in claim 1, wherein the printed circuit boards further have a processing unit mounted thereon; the processing unit being electrically connected to the transmitters, the receivers and the wireless signal transmission unit.
